(19) United States
(12) Patent Application Publication
(10) Pub. No.: US 2026/0153998 A1
(43) Pub. Date: Jun. 4, 2026

(54) STORAGE DEVICE AND CONTROL METHOD THEREFOR

(71) Applicant: Hitachi Vantara, Ltd., Kanagawa-ken (JP)

(72) Inventors: Shintaro ITO, Tokyo (JP); Taisuke ONO, Tokyo (JP); Sachie TAJIMA, Tokyo (JP)

(21) Appl. No.: 19/071,590

(22) Filed: Mar. 5, 2025

(30) Foreign Application Priority Data
Nov. 29, 2024 (JP) 2024-208924

(51) Int. Cl. G06F 3/06

(52) U.S. Cl. CPC G06F 3/0619; G06F 3/0613; G06F 3/0659; G06F 3/067

(57) ABSTRACT

When performing an operation, a processor creates a log according to an update content updated by the operation, stores the created log in a memory, and stores the log stored in the memory in a drive and non-volatilizes the log. The log is divided into a first log and a second log according to a type of the log, and the first log is divided into a plurality of groups. When processing the log, the processor processes the first log and the second log in a predetermined order, processes the first log in the groups in a predetermined order determined in the groups, and processes the first log in parallel between the groups.

### CROSS-REFERENCE TO PRIOR APPLICATION

This application relates to and claims the benefit of priority from Japanese Patent Application number 2024-208924, filed on November 29, 2024 the entire disclosure of which is incorporated herein by reference.

### BACKGROUND OF THE INVENTION

### Field of the Invention

The present invention relates to a storage device and a control method therefor.

### Description of Related Art

In related art, a redundant configuration has been adopted in a storage system in order to improve availability and reliability. For example, PTL 1 discloses the following storage system.

The storage system includes a plurality of storage nodes. Each storage node is provided with one or a plurality of storage devices that provide a storage area, and one or a plurality of pieces of control software (hereinafter referred to as storage control unit) that read and write requested data from and to the corresponding storage device in response to a request from a host device.

Each storage control unit is managed as a redundancy group in combination with another storage control unit provided in a different storage node. In addition, each storage control unit holds predetermined configuration information necessary for reading and writing requested data from and to the corresponding storage device in response to a request from the host device, and the configuration information held by each storage control unit belonging to the same redundancy group is synchronously updated.

According to such a storage system, there is an advantage that even if one storage control unit among the plurality of storage control units constituting the redundancy group is further down due to a failure or the like, the process can be taken over by another storage control unit.

However, in order to further improve the performance and reliability of the storage system having such a configuration, it is required to efficiently non-volatilize various kinds of data to prevent data loss due to a failure or the like from occurring.

In this regard, PTL 1 discloses the following method in which control information, cache data, and the like are efficiently stored in a non-volatile storage device in a storage node including a non-volatile storage device, a storage controller that controls reading and writing of data to and from the storage device, and a memory.

Specifically, in the storage node, the storage controller generates a log when reading and writing data from and to the storage device, stores the log in the log memory, and writes the log stored in the log memory to the storage device. The log includes a control information log related to update of control information and a cache data log related to update of cache data. When a log is generated, the generated control information log is stored in the log memory and written to the storage device in units of storage areas having a plurality of control information logs, the generated cache data log is stored in the log memory, and the cache data in the log memory is compressed and written to the storage device.

### Citation List

### Patent Literature

### PTL 1: JP2023-152247A

### SUMMARY OF THE INVENTION

Generally, it is necessary to guarantee the order of logs when, for example, the logs are destaged from a volatile memory to a non-volatile storage device and is non-volatilized. Therefore, in the related art, a method is adopted in which a log is stored in a single queue when the log is stored in a memory, a unique sequence number is assigned to all logs, and the logs are non-volatilized in the order of the sequence number.

However, according to such a method, there has been a problem that it is difficult to perform parallel processes by a plurality of processors due to the need for exclusive of a sequence number or the like.

The present invention has been made in view of the above points, and an object of the present invention is to propose a storage device and a control method therefor capable of performing various processes on a log in parallel and further improving performance and reliability.

In order to solve such a problem, the present invention provides a storage device that includes a processor, a volatile memory, and a plurality of non-volatile drives and performs data input and output. When performing an operation, the processor creates a log according to an update content updated by the operation, stores the created log in the memory, and stores the log stored in the memory in the drive and non-volatilizes the log. The log is divided into a first log and a second log according to a type of the log, and the first log is divided into a plurality of groups. When processing the log, the processor processes the first log and the second log in a predetermined order, processes the first log in the groups in a predetermined order determined in the groups, and processes the first log in parallel between the groups.

In addition, the present invention provides a control method for a storage device, and the storage device includes a processor, a volatile memory, and a plurality of non-volatile drives, and is configured to perform data input and output. The control method includes: when performing an operation, by the processor, creating a log according to an update content updated by the operation and storing the created log in the memory; and storing the log stored in the memory in the drive and non-volatilizing the log, the log being divided into a first log and a second log according to a type of the log, the first log being divided into a plurality of groups, and when processing the log, by the processor, a processing step of processing the first log and the second log in a predetermined order, and processing the first log in the groups in a predetermined order determined in the groups, and processing the first log in parallel between the groups.

According to the storage device and the control method therefor of the present invention, a processing speed of the process on the first and second logs can be improved, and the order of the first and second logs can be reliably guaranteed.

According to the present invention, it is possible to achieve a storage device and a control method therefor capable of improving performance and reliability.

### BRIEF DESCRIPTION OF THE DRAWINGS

FIG. 1 is a block diagram illustrating an overall configuration of a storage system according to first and second embodiments;

FIG. 2 is a block diagram illustrating a schematic physical configuration of a storage node;

FIG. 3 is a block diagram illustrating a logical configuration of the storage node;

FIG. 4 is a block diagram illustrating a characteristic configuration of a storage system according to the present embodiment;

FIG. 5 is a block diagram illustrating a logical configuration of a memory;

FIG. 6 is a table illustrating a cache directory;

FIG. 7 is a block diagram illustrating a logical configuration of a storage device;

FIG. 8 is a block diagram illustrating a module configuration of a storage control unit;

FIG. 9 is a table illustrating a log header;

FIG. 10 is a diagram illustrating a configuration of a control information type management table;

FIG. 11 is a diagram illustrating a configuration of a group management table according to a first embodiment;

FIG. 12 is a flowchart illustrating a processing procedure of a read process;

FIG. 13 is a flowchart illustrating a processing procedure of a write process;

FIG. 14 is a flowchart illustrating a processing procedure of an asynchronous destage process;

FIG. 15 is a flowchart illustrating a processing procedure of a control information update process;

FIG. 16 is a flowchart illustrating a processing procedure of a cache data update process;

FIG. 17A is a flowchart illustrating a processing procedure of a log creation process;

FIG. 17B is a flowchart illustrating a processing procedure of the log creation process;

FIG. 18 is a flowchart illustrating a processing procedure of a control information update confirmation process;

FIG. 19 is a flowchart illustrating a processing procedure of a log saving process;

FIG. 20 is a flowchart illustrating a processing procedure of a log reflection process;

FIG. 21 is a flowchart illustrating a processing procedure of a log recovery process; and

FIG. 22 is a diagram illustrating a configuration of a group management table according to a second embodiment.

### DESCRIPTION OF EMBODIMENTS

Hereinafter, embodiments of the invention will be described in detail with reference to the drawings.

The following embodiments relate to a storage system including a plurality of storage nodes in each of which one or more software defined storages (SDS) are implemented. The SDS here refers to a storage device configured with implementing software having a storage function in a general-purpose server device.

In the disclosed embodiments, the storage node includes a memory and a non-volatile device, and temporarily stores control information and cache data in the memory. When the storage node updates control information or data in response to a write request from a host device, the storage node stores the update data in a log format in the non-volatile device. Accordingly, the update data can be non-volatilized. Thereafter, a response is given to the host device.

The storage node destages the data in the memory in a storage device in a non-synchronous manner. Here, the term "destage" refers to a process of reflecting data written in the storage system and writing the data in the storage device. The same applies to the following description.

At this time, the storage system performs a process such as creating logical-physical conversion information for converting a logical address on a logical volume in which data recognized by the host device is stored into a physical address on the storage device, in order to search for data destaged in the storage device or to enable random access.

On the other hand, since the storage in the non-volatile device in the log format is intended to restore the data when the data in the memory is lost, it is not necessary to search for the data or randomly access the data. Therefore, the logical-physical conversion information as described above is not necessary, and a processing overhead for storing is small. Therefore, when a volatile memory is used, data is quickly stored in a non-volatile storage device in a log format, and a completion response is given to the host device to improve the response performance.

### First Embodiment

### Configuration of Storage System According to Present Embodiment

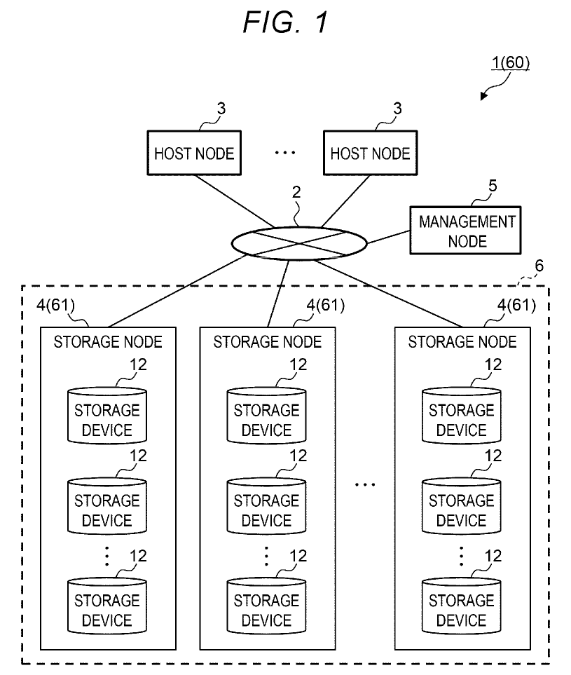

In FIG. 1, reference numeral 1 denotes a storage system according to the present embodiment as a whole. A storage system 1 includes one or a plurality of host nodes 3, a plurality of storage nodes 4, and a management node 5, which are connected to one another via a network 2 including a fiber channel (FC), Ethernet (registered trademark), a local area network (LAN), or the like.

Each of the host nodes 3 is a general-purpose computer device that functions as a host (host device) for the storage node 4. The host node 3 may be a virtual computer device such as a virtual machine. The host node 3 transmits a read command or a write command (hereinafter, collectively referred to as an input/output (I/O) command as appropriate) to the storage node 4 via the network 2 in response to a user operation or a request from an implemented application program.

The storage node 4 is a general-purpose physical server device that provides the host node 3 with a storage area for reading and writing data. A specific configuration of the storage node 4 will be described later.

The management node 5 is a computer device used by a system administrator to manage the entire storage system 1. The management node 5 collectively manages the plurality of storage nodes 4 in a group called cluster 6. FIG. 1 illustrates an example in which only one cluster 6 is provided, and a plurality of clusters 6 may be provided in the storage system 1.

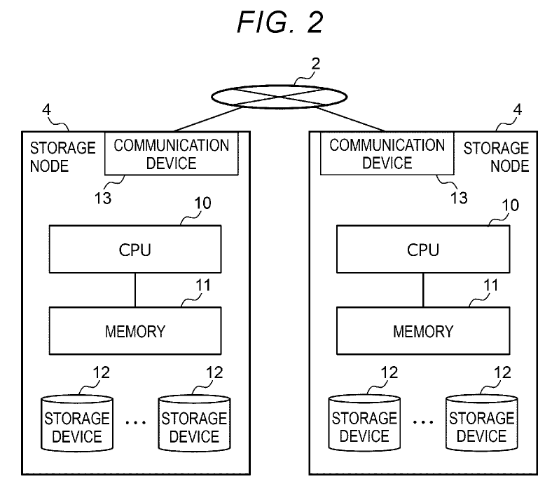

FIG. 2 illustrates a physical configuration example of the storage node 4. As illustrated in FIG. 2, the storage node 4 includes a central processing unit (CPU) 10, a memory 11, a plurality of storage devices 12, and a communication device 13.

The CPU 10 is a processor that controls operations of the overall storage node 4. The memory 11 includes a volatile semiconductor memory such as a static random access memory (Static RAM (SRAM)) or a dynamic RAM (DRAM), and is used to temporarily store programs and data. The CPU 10 executes a program stored in the memory 11 and thus executes various types of processes of the storage node 4 as a whole to be described later.

Each of the storage devices 12 includes one or a plurality of types of non-volatile and large-capacity storage devices such as a solid state drive (SSD), a serial attached small computer system interface (serial attached SCSI (SAS)) standard hard disk drive, or a serial advanced technology attachment (serial ATA (SATA)) standard hard disk drive. The storage device 12 provides a physical storage area for reading and writing data according to an I/O command from the host node 3.

The communication device 13 is an interface for the storage node 4 to communicate with an external device such as the host node 3, the management node 5, or another storage node 4 via the network 2, and is implemented by, for example, a network interface card (NIC) or an FC card. The communication device 13 performs protocol control in communication with the external device.

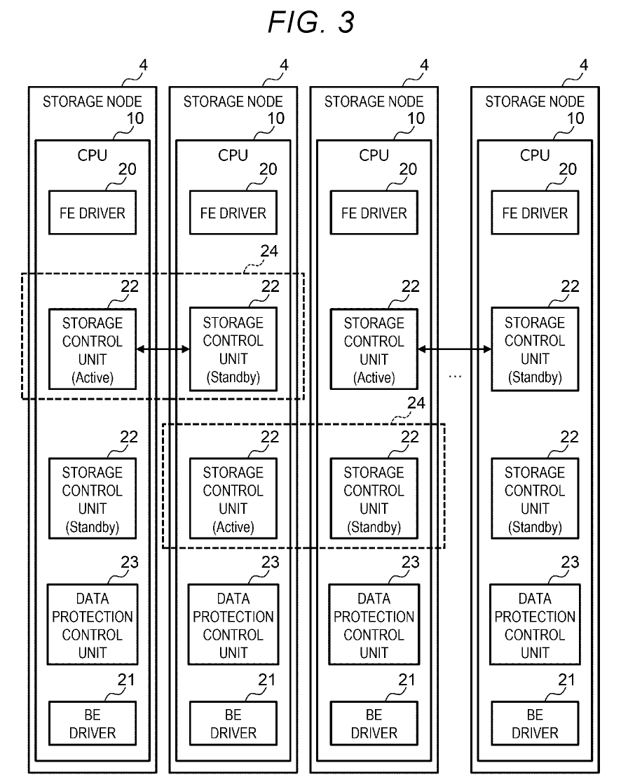

FIG. 3 illustrates a logical configuration example of the storage node 4. As illustrated in FIG. 3, each of the storage nodes 4 includes a front-end driver 20, a back-end driver 21, one or a plurality of storage control units 22, and a data protection control unit 23.

The front-end driver 20 is software that has a function of controlling the communication device 13 and providing the CPU 10 with an abstracted interface for the storage control unit 22 during communication with the host nodes 3, the management node 5 or other storage nodes 4.

The back-end driver 21 is software that has a function of controlling each storage device 12 in its own storage node 4 and providing the CPU 10 with an abstracted interface during communication with each storage device 12.

Each of the storage control units 22 is software that functions as a controller of software defined storage (SDS). The storage control unit 22 receives an I/O command from the host node 3 and issues an I/O instruction corresponding to the received I/O command to the data protection control unit 23.

The storage control unit 22 has a logical volume creation function of creating a logical volume, and provides the created logical volume to the host node 3 as a storage area for reading and writing data. Further, the storage control unit 22 associates a logical chunk created by the data protection control unit 23 with the created logical volume. The logical chunk is a logical storage area associated with a physical storage area provided by the storage device 12.

As a method of associating the logical chunk with the logical volume, a straight mapping method, a virtual volume function (Thin Provisioning) method, or the like can be applied. The straight mapping method is a method in which the logical chunk and the logical volume are associated with each other on a one-to-one basis and an address of the logical chunk and an address of the logical volume are the same. The virtual volume function method is a method in which both the logical chunk and the logical volume are divided into small size regions called pages, and the logical chunk is associated with the logical volume in units of pages.

In the case of the present embodiment, the storage control units 22 implemented in the storage node 4 are managed as a group that constitutes a redundant configuration together with other storage control units 22 provided in other storage nodes 4. Hereinafter, this group is referred to as a storage control unit group 24. The logical volumes created by the storage control units 22 constituting the storage control unit group 24 are associated with the storage control unit group 24.

FIG. 3 illustrates a case where one storage control unit group 24 is formed by two storage control units 22, and in the following description, the storage control unit group 24 is formed by two storage control units 22, and one storage control unit group 24 may be formed by three or more storage control units 22.

In the storage control unit group 24, one storage control unit 22 is set to a state where an I/O command from the host node 3 can be received (an active system state, hereinafter referred to as an active mode), and the other storage control unit 22 is set to a state where the I/O command from the host node 3 is not received (a standby system state, hereinafter referred to as a standby mode).

In response to receiving an I/O command for the logical volumes associated with the storage control unit group 24 to which the storage control unit 22 set to an active mode (hereinafter referred to as an active storage control unit) belongs, the storage control unit 22 executes an I/O process corresponding to the I/O command for the logical volumes.

In the storage control unit group 24, for example, when a failure occurs in the storage node 4 in which the active storage control unit 22 is provided, a state of the storage control unit 22 that has been set to a standby mode is switched to an active mode. Accordingly, when the active storage control unit 22 cannot operate, the I/O process executed by the active storage control unit 22 can be taken over by the standby mode storage control unit (hereinafter, referred to as a standby storage control unit) 22 (failover function).

In order to achieve such a failover function, the storage control units 22 belonging to the same storage control unit group 24 always hold the same configuration information. The configuration information is information necessary for the storage control units 22 to execute processes related to various functions such as a capacity virtualization function, a hierarchical storage control function of moving data having a high access frequency to a storage area having a higher response speed, a deduplication function of deleting duplicate data from stored data, a compression function of compressing and storing data, a Snapshot function of holding a state of data at a certain time point, and a remote copy function of copying data to a remote location in a synchronous or asynchronous manner for disaster countermeasures.

When the configuration information of the active storage control unit 22 constituting the storage control unit group 24 is updated, a difference between the configuration information before and after the update is transferred as difference data to the standby storage control unit 22 constituting the storage control unit group 24, and the configuration information held by the standby storage control unit 22 is updated by the standby storage control unit 22 based on the difference data. Accordingly, the configuration information held by each of the storage control units 22 constituting the storage control unit group 24 is always maintained in a synchronized state.

As described above, since all the storage control units 22 constituting the storage control unit group 24 always hold the configuration information having the same content, even when a failure occurs in the active storage control unit 22 or the storage node 4 in which the active storage control unit 22 is provided or the storage node 4 is removed, the standby storage control unit 22 constituting the same storage control unit group 24 as the active storage control unit 22 can immediately take over a process executed by the active storage control unit 22.

The data protection control unit 23 is software having a function of creating the above-described logical chunk and allocating, to the logical chunk, a physical storage area provided by the storage device 12 in the own storage node 4 or another storage node 4. The data protection control unit 23 also has a function of reading and writing designated data from and to the storage device 12 associated with the designated logical chunk (providing a physical storage area allocated to the logical chunk) in accordance with the above-described I/O instruction given from the storage control unit 22.

In this case, when a physical storage area provided by the storage device 12 in the other storage node 4 is allocated to the logical chunk, the data protection control unit 23 cooperates with the data protection control unit 23 implemented in the other storage node 4 to exchange data with the data protection control unit 23 via the network 2 (FIG. 1), and reads and writes the data in the storage area in accordance with an I/O request given from the active storage control unit 22 of the storage control unit group 24.

### Log Creation · Non-Volatilization Process According to Present Embodiment

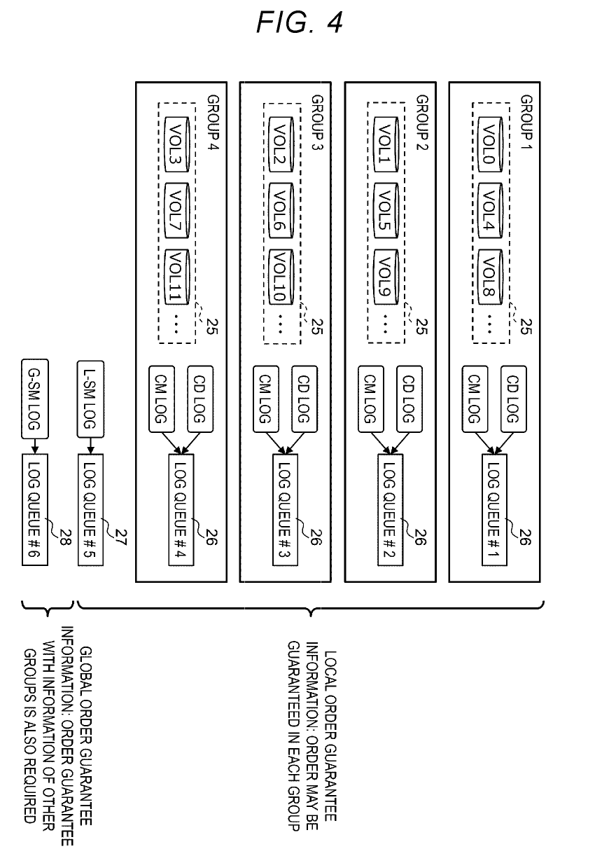

Next, an outline of a log creation · non-volatilization process executed in the storage node 4 according to the present embodiment will be described with reference to FIG. 4. First, the types of logs created by the storage control units 22 will be described.

The active storage control unit 22 of the storage node 4 updates control information or cache data for an I/O process according to an I/O command from the host node 3 or other various processes. At this time, the active storage control unit 22 creates a log related to the update along with the update of the control information or the cache data. The log created by the active storage control unit 22 includes a local order guarantee information log and a global order guarantee information log.

The local order guarantee information log includes an update log of cache directory information (hereinafter referred to as a cache directory (CD) log), which is a type of control information, and an update log of cache data (hereinafter referred to as a cache memory (CM) log).

Other logs related to logical information include a local shared memory (L-SM) log and a global shared memory (G-SM) log.

The L-SM log is a log related to I/O statistical information, trace information, or the like, which is a type of control information, and corresponds to the local order guarantee information log. The I/O statistical information is statistical information on a log such as the number of received read commands and write commands and the number of I/Os for each logical volume. The trace information is log information used for some analysis such as the number of error logs. These pieces of control information do not need strict consistency with other pieces of information, and are information cleared at the time of startup from failover or power interruption.

The G-SM log is a log related to configuration information such as creation of a logical volume and setting of an access path, and corresponds to a global order guarantee information log. These pieces of control information are information require strict consistency with other information.

In the following description, control information and cache data in which a CD log, a CM log, or an L-SM log is created at the time of update are referred to as local order guarantee information, and control information in which a G-SM log is created at the time of update is referred to as global order guarantee information.

In the storage system 1 according to the present embodiment, as illustrated in FIG. 4, the logical volumes (VOL0 to VOL11 in FIG. 4) associated with one storage control unit group 24 are divided into a predetermined number of two or more groups (hereinafter referred to as local groups) 25 set in advance, and a first local order guarantee information log queue 26 is created in advance in association with each local group 25. The CD log and the CM log created in association with the logical volumes belonging to one local group 25 are stored (en-queued) as one log group in the first local order guarantee information log queue 26 created in association with the local group 25 to which the logical volumes belongs.

In the storage system 1, one second local order guarantee information log queue 27 is provided for the storage control unit group 24, and all the L-SM logs created in association with the storage control unit group 24 are stored in the second local order guarantee information log queue 27 as one log group. Further, in the storage system 1, one global order guarantee information log queue 28 is provided for the storage control unit group 24, and all the G-SM logs created in association with the storage control unit group 24 are stored in the global order guarantee information log queue 28 as one log group.

The CD log and the CM log stored in each first local order guarantee information log queue 26 are read in order from the first local order guarantee information log queue 26 in parallel with the other first local order guarantee information log queues 26, and are subjected to a process such as non-volatilization or transferring.

The L-SM logs stored in the second local order guarantee information log queue 27 and the G-SM logs stored in the global order guarantee information log queue 28 are also read from the second local order guarantee information log queue 27 and the global order guarantee information log queue 28 in parallel with other log queues (the first local order guarantee information log queue 26, the second local order guarantee information log queue 27, and or the global order guarantee information log queue 28), and are subjected to a process such as non-volatilization or transferring.

However, the group of the CD log and the CM log created for logical volumes belonging to one local group 25 may be configured with a first group including the CD log and a second group including the CM log, and a first local order guarantee information log queue for the first group (hereinafter referred to as a first local order guarantee information log queue for the CD log) and a first local order guarantee information log queue for the second group (hereinafter referred to as a first local order guarantee information log queue for the CM log) may be provided.

In this case, the CD log created for each logical volume belonging to the corresponding local group 25 is stored in the first local order guarantee information log queue for the CD log, and the CM log created for each logical volume belonging to the local group 25 is stored in the first local order guarantee information log queue for the CM log. Thus, the CD log and the CM log created for each logical volume belonging to the same local group 25 can be subjected to a process such as non-volatilization or transferring in parallel.

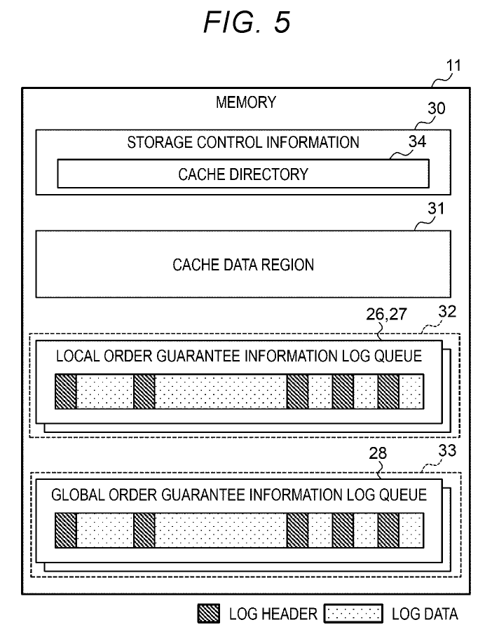

FIG. 5 illustrates a logical configuration example of the memory 11 in each storage node 4. As illustrated in FIG. 5, a storage control information region 30, a cache data region 31, a local order guarantee information log queue region 32, and a global order guarantee information log queue region 33 are defined in the memory 11 of the storage node 4.

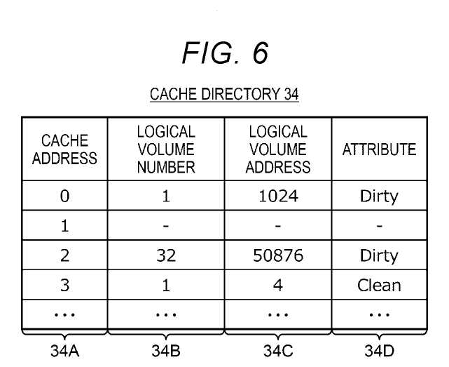

The storage control information region 30 is a region where control information for implementing various storage functions is stored. Such control information includes a cache directory 34. The cache directory 34 is management information of individual small regions (hereinafter referred to as cache segments) obtained by subdividing the cache data region 31, and holds entries (rows) corresponding to the cache segments, as illustrated in FIG. 6.

Each entry includes a cache address column 34A, a logical volume number column 34B, a logical volume address column 34C, and an attribute column 34D. The cache address column 34A stores a head address (cache address) on the memory 11 of the cache segment corresponding to the entry.

The logical volume number column 34B stores an identification number of a logical volume to which data stored in a cache segment corresponding to the entry is written, and the logical volume address column 34C stores a head address (logical volume address) of a storage area in which the data in the logical volume is written. When no data is stored in the corresponding cache segment, "‐" indicating that there is no value is stored.

Further, when data (cache data) is stored in the cache segment, an attribute of the data is stored in the attribute column 34. The attribute of the data in this case includes "Dirty", which means that the data has not yet been destaged and the data has not been written to the storage device 12 (FIGS. 1 and 2), and "Clean", which means that the data has been destaged and matches a value written to the storage device 12.

Referring back to FIG. 5, the cache data region 31 is a cache region for temporarily storing data. The above-described "cache data" refers to data stored in the cache data region 31, and hereinafter, the data stored in the cache data region 31 is also referred to as cache data as appropriate.

In the local order guarantee information log queue region 32, the first local order guarantee information log queue 26 and the second local order guarantee information log queue 27 for each of the required number of storage control unit groups 24 described above with reference to FIG. 4 are created. A corresponding CD log and CM log created by the corresponding storage control unit group 24 are temporarily stored in each first local order guarantee information log queue 26, and an L-SM log created by the corresponding storage control unit group 24 is temporarily stored in each second local order guarantee information log queue 27.

Further, in the global order guarantee information log queue region 33, the global order guarantee information log queue 28 for each storage control unit group 24 described above with reference to FIG. 4 is created, and a G-SM log created by the corresponding storage control unit group 24 is temporarily stored in the global order guarantee information log queue 28.

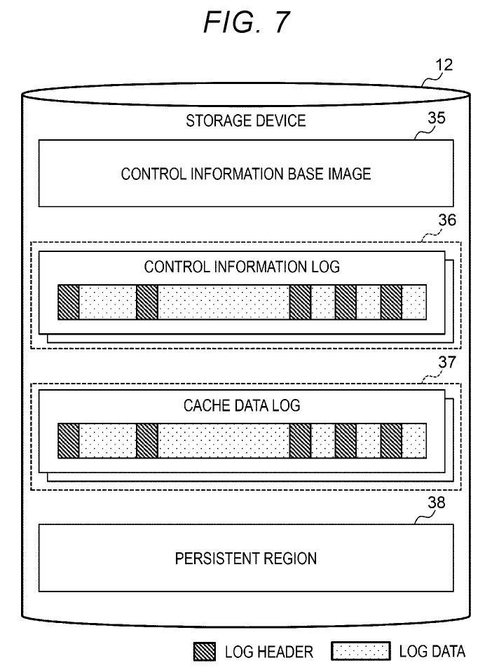

On the other hand, FIG. 7 illustrates a logical configuration example of the storage device 12 in the storage node 4. As illustrated in FIG. 7, a control information base image region 35, a control information log region 36, a cache data log region 37, and a persistent region 38 are defined in the storage device 12 of the storage node 4.

The control information base image region 35 is a region for storing the entire control information at a certain point in time in the past. In practice, in the control information base image region 35, for example, the entire control information stored in the storage control information region 30 (FIG. 5) of the memory 11 at the time of activation of the storage node 4 or at regular timing is stored as a base image.

The control information log region 36 and the cache data log region 37 are regions for saving various types of control information logs and cache data logs in a log saving process to be described later. The persistent region 38 is a region for storing user data (data written by a user) managed by the data protection control unit 23 (FIG. 3).

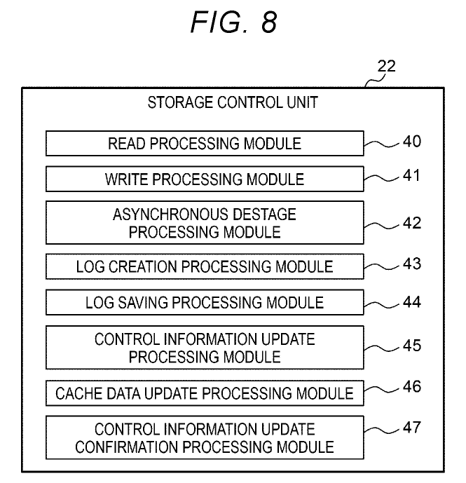

FIG. 8 illustrates an example of a software module configuration of the storage control unit 22 (FIG. 3) mounted on the storage node 4. The storage control unit 22 includes, as software modules, a read processing module 40, a write processing module 41, an asynchronous destage processing module 42, a log creation processing module 43, a log saving processing module 44, a control information update processing module 45, a cache data update processing module 46, a control information update confirmation processing module 47, and a log recovery processing module 48. The functions of these software modules will be described later.

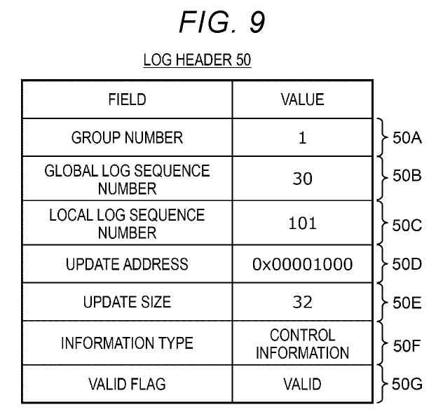

FIG. 9 illustrates a structure example of a log header 50 in the storage node 4. The log header 50 is control information added to heads of logs stored in the local order guarantee information log queue region 32 and the global order guarantee information log queue region 33 on the memory 11 described above with reference to FIG. 5 and the control information log region 36 and the cache data log region 37 on the storage device 12 described above with reference to FIG. 7.

As illustrated in FIG. 9, the log header 50 has a table structure including a group number field 50A, a global log sequence number field 50B, a local log sequence number field 50C, an update address field 50D, an update size field 50E, an information type field 50F, and a valid flag field 50G.

When the log header 50 is added to a head of a local order guarantee information log, an identifier (group number) unique to the local group 25 assigned to the local group 25 (FIG. 4) to which the logical volume related to the local order guarantee information log belongs is stored in the group number field 50A. When the log header 50 is added to a head of a global order guarantee information log, a special number (for example, "0") indicating that the log is a global order guarantee information log is stored.

Combinations of log sequence numbers uniquely assigned to the logs are stored in the global log sequence number field 50B and the local log sequence number field 50C.

For example, when the log is a global order guarantee information log, a sequence number (global log sequence number) assigned to the global order guarantee information log to guarantee the order of the global order guarantee information log is stored in the global log sequence number field 50B, and an invalid value ("‐") is stored in the local log sequence number field 50C. As the global log sequence number, for example, a serial number starting from "1" can be applied. Other numbers may be applied as long as the number can guarantee the order of the global order guarantee information log.

When the log is a local order guarantee information log, the latest global log sequence number is stored in the global log sequence number field 50B, and a sequence number (local log sequence number) assigned to the local order guarantee information log to guarantee the order of the local order guarantee log in the group is stored in the local log sequence number field 50C. As the local log sequence number, for example, a serial number starting from "1" can be applied. Other numbers may be applied as long as the number can guarantee the order of the local order guarantee information log.

The update address field 50D stores an address on the storage control information region 50 (in the case of control information) or the cache data region 31 (in the case of cache data) of the memory 11 in which update target control information or update target cache data is stored. The update size field 50E stores a data size of control information or cache data to be updated.

The information type field 50F stores information indicating whether a target of the log (updated when the log is created) is control information or cache data. In the example of FIG. 9, a character string "control information" is stored when the target is control information, and a character string "cache data" is stored when the target is cache data.

Further, the valid flag field 50G stores a valid flag indicating whether the log is valid. In the example of FIG. 9, a character string "valid" is stored when the log is valid, and a character string "invalid" is stored when the log is invalid.

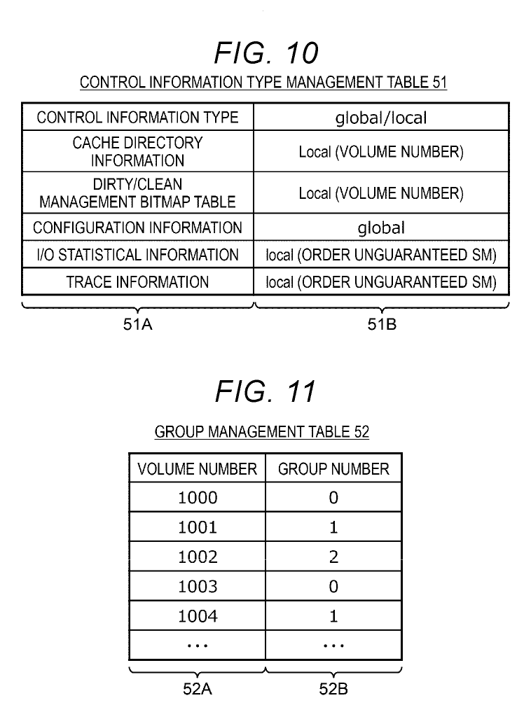

FIG. 10 illustrates a configuration example of the control information type management table 51. The control information type management table 51 is a table in which types of various types of control information (global order guarantee information or local order guarantee information) are stored, and is created in advance and stored in the memory 11.

As illustrated in FIG. 10, the control information type management table 51 includes a control information type column 51A and a global/local column 51B. The control information type column 51A stores names of configuration information such as "cache directory information", "dirty/clean management bitmap table", "configuration information", "I/O statistical information", and "trace information".

The global/local column 51B stores a character string "global" when the corresponding control information is global order guarantee information, and stores a character string "local" when the corresponding control information is local order guarantee information.

Since the cache directory information and a bitmap table (dirty/clean management bitmap table) indicating whether data stored in each small region in a logical volume is dirty data or clean data are managed separately for each local group 25 (FIG. 4), a volume number of the corresponding logical volume after the character string "local" is stored in the control information type column 51A corresponding to "cache directory information" or "dirty/clean management bitmap table" of the control information type management table 51.

Since the I/O statistical information and the trace information are not managed separately by the volume number of the corresponding logical volume and are information that does not require order guarantee and is related to the shared memory, the control information type column 51A corresponding to "I/O statistical information" and "trace information" of the control information type management table 51 stores a character string "(order unguaranteed SM)" indicating the fact after the character string "local".

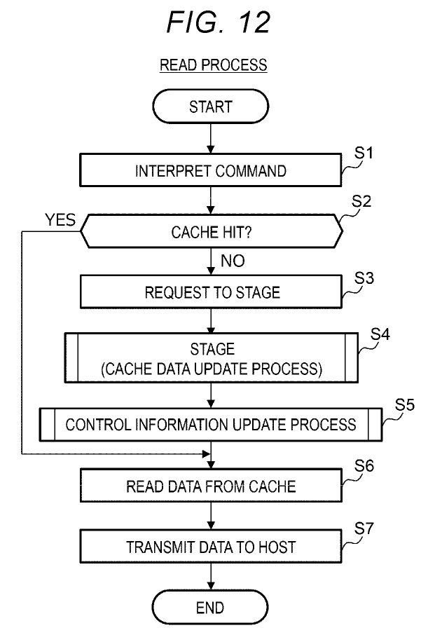

On the other hand, FIG. 11 illustrates a configuration example of the group management table 52. The group management table 52 is created by the active storage control unit 22 (FIG. 3) for each storage control unit group 24 (FIG. 3). The group management table 52 is used to manage to which local group 25 (FIG. 4) a logical volume associated with the corresponding storage control unit group 24 belongs.

In the group management table 52, one entry (row) corresponds to one logical volume, and each time a new logical volume is created and the logical volume is allocated to one of the local groups 25, the logical volume is registered in the group management table 52. The group management table 52 is stored and managed in a predetermined position of the memory 11.

As illustrated in FIG. 11, the group management table 52 includes a volume number column 52A and a group number column 52B. The volume number column 52A stores volume numbers of all the logical volumes associated with the corresponding storage control unit group 24. The group number column 52B stores an identification number (local group number) of the local group 25 to which the corresponding logical volume (logical volume having the volume number of the same row) is allocated.

Accordingly, the storage control unit 22 can detect to which local group 25 a logical volume belongs by searching the group management table 52 using a volume number of the logical volume as a key. As a result, the storage control unit 22 can determine in which of the first local order guarantee information log queues 26 (FIG. 4) a local order guarantee information log is to be stored. Incidentally, when there is control information using information other than the volume number of the logical volume as a key, it is necessary to create another group management table corresponding to the control information.

As a method of allocating a logical volume to each local group 25, various allocation methods such as a method of allocating a logical volume to the corresponding local group 25 according to a volume number assigned to the created logical volume or a method of allocating a logical volume to each local group 25 using a random number can be widely applied.

For example, in a method of allocating a logical volume to a local group 25 based on a volume number of the logical volume, the volume number may be divided by the number of local groups 25, and the logical volume may be allocated to the local group 25 according to the value of the remainder. For example, if the remainder is "0", the logical volume may be allocated to the first local group 25, and if the remainder is "1", the logical volume may be allocated to the second local group 25.

### Various Processes Executed in Storage Node

Next, specific contents of various processes executed in the storage node 4 will be described. In the following, a processing entity of various processes will be described as a software module ("…… module") of the storage control unit 22 described above with reference to FIG. 7, but it is needless to say that the storage control unit 22 (and thus the CPU 10 (FIG. 2) of the storage node 4) actually executes the process based on the software module.

### Read Process

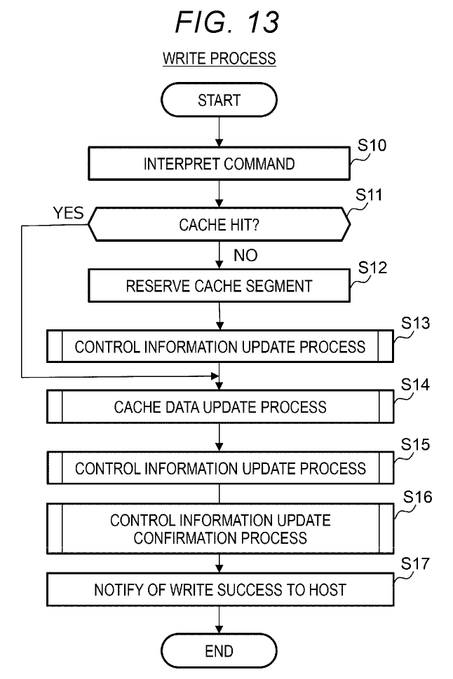

FIG. 12 illustrates a flow of a read process executed in the storage node 4 when a read command designating a logical volume and a logical volume address of a read destination is given from the host node 3 to the storage node 4.

This read process is executed by the read processing module 40, the control information update processing module 45, the cache data update processing module 46, and the like described above with reference to FIG. 8 in the active storage control unit 22 of the storage control unit group 24 associated with the logical volume of the read destination.

In practice, when the active storage control unit 22 of the storage control unit group 24 receives a read command from the host node 3, the read processing module 40 first interprets the content of the received read command, and acquires a volume number of the logical volume of the read destination and a logical volume address of the read destination in the logical volume (S1).

The read processing module 40 determines whether read target data is stored in the cache data region 31 (FIG. 5) of the memory 11 (FIG. 5) (S2). Specifically, the read processing module 40 searches the cache directory 34 (FIG. 6) of the memory 11 for an entry of data stored in the logical volume address acquired in step S1 in the logical volume of the volume number acquired in step S1, and determines whether the entry could be detected.

If a positive result is obtained in this determination (cache hit), the read processing module 40 acquires, from the entry, a cache address on the cache data region 31 of the memory 11 in which the read target data is stored, and reads cache data stored at the cache address in the cache data region 31 (S7).

The read processing module 40 transmits the cache data read in step S6 to the host node 3 (S8), and then ends the read process.

On the other hand, if a negative result is obtained in the determination of step S2 (cache miss), the read processing module 40 requests the data protection control unit 23 (FIG. 3) to stage the read target data using the logical volume number and the logical volume address acquired in step S1 as arguments (S3).

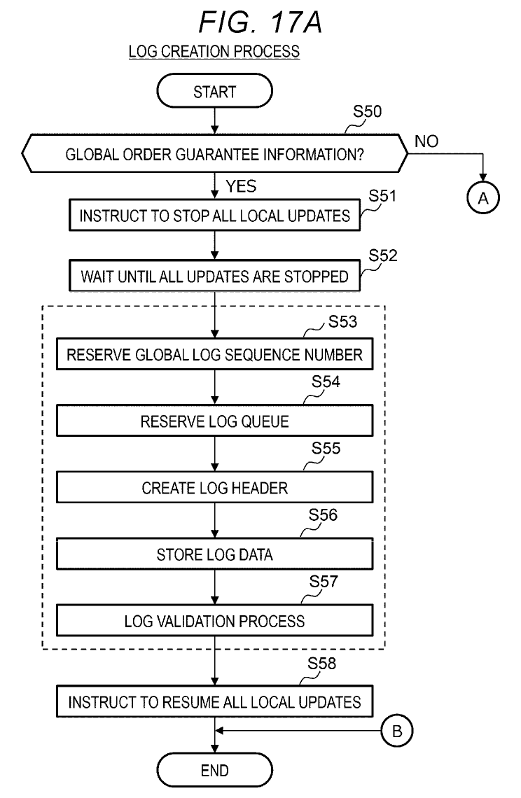

The data protection control unit 23 that has received the request stages the requested data in cooperation with the cache data update processing module 46 (S4). Specifically, the data protection control unit 23 reads data corresponding to the logical volume number and the logical volume address described above from the persistent region 38 (FIG. 7) on the storage device 12 (FIG. 7), sets the non-volatilization to "unnecessary", and calls the cache data update processing module 46. The cache data update processing module 46 called by the data protection control unit 23 stores the data read from the storage device 12 by the data protection control unit 23 in the cache data region 31 on the memory 11 by executing a cache data update process to be described later with reference to FIG. 16.

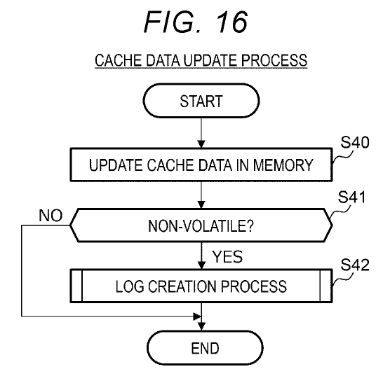

Thereafter, the cache data update processing module 46 sets non-volatilization to "unnecessary" and calls the control information update processing module 45. The control information update processing module 45 called by the cache data update processing module 46 updates the cache directory 34 (FIG. 6) stored in the storage control information region 30 of the memory 11 by executing a control information update process to be described later with reference to FIG. 15 (S5).

Thereafter, the read processing module 40 reads read target data staged in step S4 from the cache data region 31 of the memory 11 (S6), and transmits the read data to the host node 3 (S7). Accordingly, the read process ends.

### Write Process

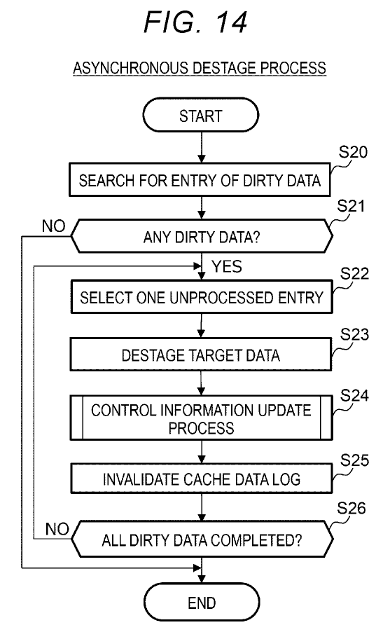

On the other hand, FIG. 13 illustrates a flow of a write process executed in the storage node 4 when write target data and a write command designating a logical volume and a logical volume address of a write destination are given from the host node 3 to the storage node 4.

This write process is executed by the write processing module 41, the control information update processing module 45, the cache data update processing module 46, the control information update confirmation processing module 47, and the like described above with reference to FIG. 8 in the active storage control unit 22 of the storage control unit group 24 associated with the logical volume of the write destination.

In practice, when the active storage control unit 22 of the storage control unit group 24 receives a write command from the host node 3, the write processing module 41 first interprets the content of the received write command, and acquires a volume number of the logical volume of the write destination and a logical volume address of the write destination in the logical volume (S10).

The write processing module 41 determines whether data (hereinafter referred to as preceding data) has been already stored in the logical volume address acquired in step S1 in the logical volume of the logical volume number acquired in step S10 (S11).

Specifically, the write processing module 41 searches the cache directory 34 (FIG. 6) of the memory 11 for an entry of data stored in the logical volume address acquired in step S10 in the logical volume of the volume number acquired in step S10, and determines whether the entry could be detected.

When a positive result is obtained in this determination (cache hit), the write processing module 41 acquires, from the entry, a cache address in the cache data region 31 of the memory 11 in which the preceding data is stored, sets the necessity of non-volatilization to "necessary", and calls the cache data update processing module 46. The cache data update processing module 46 called by the write processing module 41 overwrites the cache address acquired by the write processing module 41 with write target data as described above by executing the cache data update process to be described later with reference to FIG. 16 (S14).

Subsequently, the write processing module 41 sets the necessity of non-volatilization to "necessary" and calls the control information update processing module 45 (FIG. 8). The control information update processing module 45 called by the write processing module 41 updates the cache directory 34 (FIG. 6) according to the processing content of step S14 by executing the control information update process to be described later with reference to FIG. 15 (S15).

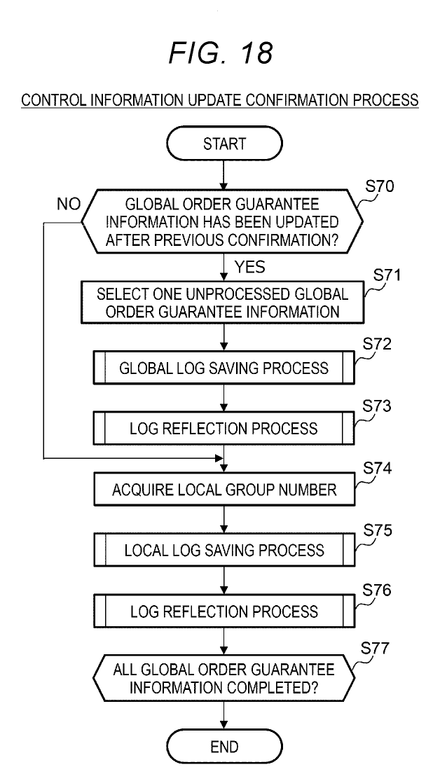

Next, the write processing module 41 calls the control information update confirmation processing module 47 (FIG. 8). The control information update confirmation processing module 47 called by the write processing module 41 executes a control information update confirmation process to be described later with reference to FIG. 18 to save the corresponding local order guarantee information logs stored in the first and second local order guarantee information log queues 26,27 in the local order guarantee information log queue region 32 of the memory 11 and the corresponding global order guarantee information logs stored in the global order guarantee information log queue 28 in the global order guarantee information log queue region 33 of the memory 11 in the control information log region 36 (FIG. 7) of the storage device 12 (S16).

Further, the write processing module 41 transmits, to the host node 3, a response indicating that the write of the write target data is successful (S18), and then ends the write process.

On the other hand, if a negative result is obtained in the determination of step S11 (cache miss), the write processing module 41 secures a cache segment having a size corresponding to the data size of the write target data in the cache data region 31 (FIG. 5) of the memory 11 (S12).

The write processing module 41 sets the necessity of non-volatilization to "necessary" and calls the control information update processing module 45. Thus, the control information update processing module 45 called by the write processing module 41 registers necessary information such as a logical volume number and a logical volume address related to the write target data in the cache directory 34 (FIG. 6) for the cache segment reserved by the write processing module 41 in step S12 by executing the control information update process to be described later with reference to FIG. 15 (S13).

Further, the write processing module processes step S14 to step S17 in the same manner as described above, and then ends the write process.

### Asynchronous Destage Process

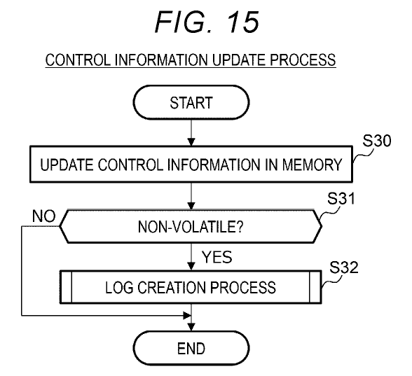

FIG. 14 illustrates a flow of an asynchronous destage process periodically executed by the asynchronous destage processing module 42 (FIG. 8), the control information update processing module 45, and the like. Here, "destage" means that the data stored in the memory 11 is stored in the storage device 12 and the data is non-volatilized.

When the asynchronous destage processing module 42 starts the asynchronous destage process, the asynchronous destage processing module 42 first searches the cache directory 34 in the memory 11 for an entry whose attribute is "Dirty" (entry in which "Dirty" is stored in the attribute column 34D described above with reference to FIG. 6) (S20).

Subsequently, the asynchronous destage processing module 42 determines whether the entry could be detected in the search in step S20 (S21). If a negative result is obtained in this determination, the asynchronous destage processing module 42 ends this asynchronous destage processing.

On the other hand, when a positive result is obtained in the determination of step S21, the asynchronous destage processing module 42 selects one unprocessed entry whose attribute is "Dirty", and requests the data protection control unit 23 (FIG. 3) to destage the data stored in the cache segment corresponding to the selected entry (S22).

Thus, the data protection control unit 23 having received the request destages the data (S23). Specifically, the data protection control unit 23 acquires information on the entry (cache address, logical volume number, and logical volume address) from the cache directory 34, and reads the corresponding data from the cache data region 31 (FIG. 5) based on the acquired information. Further, the data protection control unit 23 writes the read data to the persistent region 38 (FIG. 7) on the storage device 12. At this time, the data protection control unit 23 may make the data redundant using a technique such as mirroring or erasure coding (EC).

Thereafter, the asynchronous destage processing module 42 sets the necessity of non-volatilization to "necessary", calls the control information update processing module 45, and executes the control information change process to be described later with reference to FIG. 15, thereby deleting the entry corresponding to the data destaged in step S23 from the cache directory 34 (S24).

Subsequently, the asynchronous destage processing module 42 invalidates the corresponding cache data log (S25). Specifically, the asynchronous destage processing module 42 changes, to "invalid", a value stored in the valid flag field 50G in the log header 50 (FIG. 9) of the cache data log at the same address as the destaged data. The cache data log invalidated in this way is then deleted from the first local order guarantee information log queue 26 (FIG. 4) by a periodic predetermined process.

Next, the asynchronous destage processing module 42 determines whether the processes of step S23 to step S26 have been completed for all entries in which "Dirty" is stored in the attribute column 34D (FIG. 6) in the cache directory 34 (26).

If a negative result is obtained in this determination, the asynchronous destage processing module 42 returns to step S22, and then repeats the processes of step S22 to step S26 while sequentially switching the entry selected in step S22 to another corresponding entry that has not been processed in step S23 and subsequent steps.

If a positive result is obtained in step S26 by completing the processes of step S23 to step S25 for all the corresponding entries of the cache directory 34, the asynchronous destage processing module 42 ends the asynchronous destage process.

### Control Information Update Process

FIG. 15 illustrates a flow of a control information update process executed by the control information update processing module 45, the log creation processing module 43, and the like in step S6 of the read process described above with reference to FIG. 12, step S13 and step S16 of the write process described above with reference to FIG. 13, and step S24 of the asynchronous destage process described above with reference to FIG. 14.

In practice, when the control information update processing module 45 is called by the read processing module 40, the write processing module 41, or the asynchronous destage processing module 42 in step S6 of the read process, step S13 or step S16 of the write process, or step S24 of the asynchronous destage process, the control information update processing module 45 starts the control information update process illustrated in FIG. 15.

At this time, the control information update processing module 45 is notified of an address in the storage control information region 30 of the memory 11 in which update target control information is stored, a size of the control information, an update value, and information indicating the necessity of non-volatilization from the read processing module 40, the write processing module 41, or the asynchronous destage processing module 42.

The control information update processing module 45 first updates the corresponding control information stored in the storage control information region 30 of the memory 11 to the update value notified from the read processing module 40, the write processing module 41, or the asynchronous destage processing module 42 as described above (S30).

Subsequently, the control information update processing module 45 determines whether the necessity of non-volatilization notified from the read processing module 40, the write processing module 41, or the asynchronous destage processing module 42 is "necessary" (S31). If a negative result is obtained in this determination, the control information update processing module 45 ends this control information update process.

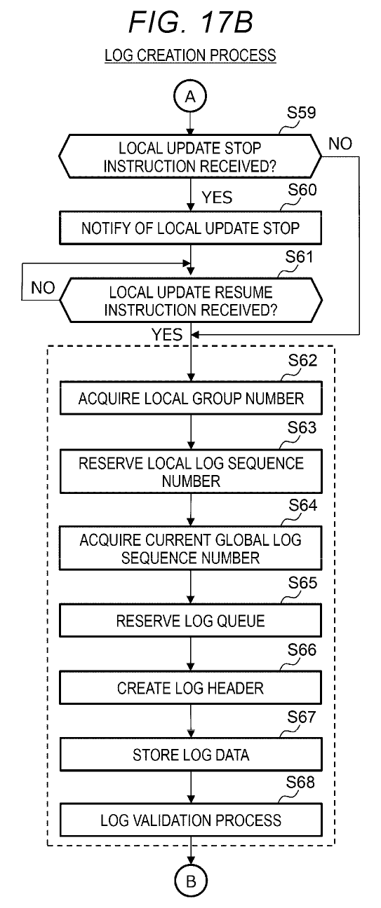

On the other hand, if a positive result is obtained in the determination of step S31, the control information update processing module 45 calls the log creation processing module 43 (FIG. 8) and executes a log creation process to be described later with reference to FIGS. 17A and 17B to create a corresponding log (global order guarantee information log or local order guarantee information log) (S32). Then, the control information update processing module 45 ends the control information update process.

### Cache Data Update Process

FIG. 16 illustrates a flow of the cache data update process executed by the cache data update processing module 46 called in step S4 of the read process described above with reference to FIG. 12 or in step S14 of the write process described above with reference to FIG. 13 and the log creation processing module 43 called by the cache data update processing module 46.

In practice, when the cache data update processing module 46 is called by the read processing module 40 or the write processing module 41 in step S4 of the read process or step S14 of the write process, the cache data update processing module 46 starts the cache data update process illustrated in FIG. 16.

At this time, the cache data update processing module 46 is notified of an address in the cache data region 31 of the memory 11 in which update target cache data is stored, a size of the cache data, an update value, and information indicating the necessity of non-volatilization from the read processing module 40 or the write processing module 41.

The cache data update processing module 46 first updates the corresponding data (hereinafter referred to as cache data) stored in the cache data region 31 of the memory 11 to the update value notified from the read processing module 40 or the write processing module 41 as described above (S40).

Subsequently, the cache data update processing module 46 determines whether the necessity of non-volatilization notified from the read processing module 40 or the write processing module 41 is "necessary" (S41). If a negative result is obtained in this determination, the cache data update processing module 46 ends this cache data update process.

On the other hand, a positive result is obtained in this determination, the cache data update processing module 46 calls the log creation processing module 43. Thus, the log creation processing module 43 called by the cache data update processing module 46 creates a log (local order guarantee information log) for the update of the cache data performed in step S40 by executing the log creation process to be described later with reference to FIGS. 17A and 17B (S42).

Then, the cache data update processing module 46 ends the cache data update process.

### Log Creation Process

FIGS. 17A and 17B illustrate a flow of the log creation process executed by the log creation processing module 43 called in step S32 of the control information update process described above with reference to FIG. 15 or in step S42 of the cache data update process described above with reference to FIG. 16. The log creation processing module 43 creates a corresponding log according to the processing procedure illustrated in FIGS. 17A and 17B.

In practice, when the log creation processing module 43 is called in step S32 of the control information update process or step S42 of the cache data update process, the log creation processing module 43 starts the log creation process illustrated in FIGS. 17A and 17B.

The log creation processing module 43 first determines whether the updated information is global order guarantee information (S50). This determination can be made, for example, by determining whether the type of the control information stored in the global/local column 51B of the row corresponding to the information in the control information type management table 51 (FIG. 10) is "global".

If a positive result is obtained in this determination, when the local order guarantee information of each local group 25 described above with reference to FIG. 4 is updated in parallel by a plurality of CPU cores of the CPU 10 (FIG. 2), the log creation processing module 43 transmits an instruction to stop the update of all the local order guarantee information (hereinafter, referred to as a local update stop instruction) to the corresponding CPU core (S51). Thereafter, the log creation processing module 43 waits for all the CPU cores to stop the update process of the local order guarantee information log (S52).

As a method of determining, by the log creation processing module 43, whether the update process of all the local order guarantee information logs has been stopped, various determination methods can be applied. For example, a CPU core that has stopped updating the local order guarantee information log may set a flag to that effect at a predetermined position in the memory 11, and the log creation processing module 43 that has transmitted the local update stop instruction may make a determination on the state of the flag. Alternatively, the determination may be made using an inter-processor communication function such as semaphore or socket communication.

When it is confirmed that all the CPU cores have stopped the update process of the local order guarantee information log, the log creation processing module 43 creates a global order guarantee information log corresponding to the processes of steps S53 to S57.

In practice, the log creation processing module 43 first reserves a new global log sequence number (S53). As described above with reference to FIG. 9, the global log sequence number is an identification number unique to the global order guarantee information log assigned to the global order guarantee information log in the order of creation. The log creation processing module 43 reserves a region for writing the next global order guarantee information log in the global order guarantee information log queue 28 (FIG. 4) (S54).

When the log creation process is executed in parallel by the plurality of CPU cores, it is necessary to perform an exclusive process so that the same global log sequence number is not acquired by another process and a region of the same log queue is not reserved by another process.

Subsequently, the log creation processing module 43 creates the log header 50 (FIG. 9) of a global order guarantee information log to be created at that time (S55). Specifically, the log creation processing module 43 stores the global log sequence number reserved in step S53 in the global log sequence number field 50B of the log header 50. Further, the log creation processing module 43 stores, in the update address field 50D and the update size field 50E, values of an update destination address and an update size on the memory 11 notified when the log creation processing module 43 is called by the control information update processing module 45 (FIG. 8) or the cache data update processing module 46 (FIG. 8). Further, the log creation processing module 43 stores, in the information type field 50F, "control information" at the time of updating the control information or "cache data" at the time of updating the cache data.

Next, the log creation processing module 43 stores the global order guarantee information log in the global order guarantee information log queue 28 (FIG. 4) (S56). The global order guarantee information log includes the log header 50 and update target data. Therefore, the log creation processing module 43 stores the log header 50 created in step S55 at the head of the region reserved in step S54 (hereinafter referred to as a reserved region) in the global order guarantee information log queue 28, and stores the update target data at an address position obtained by adding data size of the log header 50 to a head address of the reserved region.

The log creation processing module 43 sets, to "valid", a value stored in the valid flag field 50G of the log header 50 of the global order guarantee information log stored in the global order guarantee information log queue 28 in step S56 (S57).

Subsequently, the log creation processing module 43 transmits an instruction (hereinafter, referred to as a local update resume instruction) to resume an update process of the local order guarantee information to all the CPU cores of the CPU 10 (FIG. 2) that updates the local order guarantee information in parallel (S58), and then ends the log creation process.

On the other hand, if a negative result is obtained in the determination of step S50, the log creation processing module 43 determines whether a local update stop instruction has been received from another CPU core of the CPU 10 (FIG. 2) that updates the local order guarantee information in parallel (S59). If a negative result is obtained in this determination, the log creation processing module 43 proceeds to step S62.

On the other hand, if a positive result is obtained in the determination of step S59, the log creation processing module 43 notifies the CPU core of a transmission source of the local update stop instruction that the update process of the local order guarantee information is stopped (S60), and then waits for a local update resume instruction to be transmitted from the CPU core (S61).

When the log creation processing module 43 receives a local update resume instruction from the CPU core, the log creation processing module 43 creates a corresponding local order guarantee information log by the processes in step S62 to step S68.

In practice, the log creation processing module 43 first specifies the local group 25 (FIG. 4) to which a logical volume corresponding to update target local order guarantee information belongs, and acquires a local group number of the logical volume (S62).

For example, when the type of update target information is "local", the volume number of the logical volume corresponding to the update target local order guarantee information is stored following the character string "local" in the global/local column 51B of the row corresponding to the information in the control information type management table 51 (FIG. 10), so that the log creation processing module 43 acquires the volume number. The log creation processing module 43 searches the group management table 52 (FIG. 11) using the volume number acquired in this way as a key, thereby acquiring a local group number of the local group 25 to which a logical volume to which the volume number is assigned belongs.

Subsequently, the log creation processing module 43 reserves a new local log sequence number (S63) and acquires a current global log sequence number (S64). As in step S54, the log creation processing module 43 reserves a region for writing the next local order guarantee information log in the corresponding first or second local order guarantee information log queue 26,27 (FIG. 4) (S65).

Next, the log creation processing module 43 generates the log header 50 as in step S55 (S66). At this time, the log creation processing module 43 stores the global log sequence number acquired in step S64 in the global log sequence number field 50B of the log header 50.

Further, as in step S56, the log creation processing module 43 stores the local order guarantee information log including the log header 50 created in step S66 and the update target data in the region reserved in step S65 of the corresponding first or second local order guarantee information log queue 26,27 (S67).

Thereafter, the log creation processing module 43 sets, to "valid", a value stored in the valid flag field 50G of the log header 50 of the local order guarantee information log stored in the first or second local order guarantee information log queue 26,27 in step S67 (S68). The log creation processing module 43 ends the creation of the corresponding local order guarantee information log, and then ends the log creation process.

### Control Information Update Confirmation Process

FIG. 18 illustrates a flow of the control information update confirmation process executed by the control information update confirmation processing module 47 called in step S17 of the write process described above with reference to FIG. 13. The control information update confirmation processing module 47 confirms the update of the corresponding control information according to the processing procedure illustrated in FIG. 18.

When the control information update confirmation processing module 47 is called by the write processing module 41 in step S17 of the write process, the write processing module 41 notifies the control information update confirmation processing module 47 of a logical volume number of a logical volume of a write destination of data.

When the control information update confirmation processing module 47 is called by the write processing module 41 in step S17 of the write process, the control information update confirmation processing module 47 starts the control information update confirmation process illustrated in FIG. 18, and determines whether the global order guarantee information has been updated from the previous control information update confirmation process until the present (S70).

As a method for making such a determination, a method can be applied in which, when the global order guarantee information is updated, a software module that has performed the update sets a flag in a specific storage area in the memory 11 or the storage device 12, and the flag is set in the control information update confirmation process. If a negative result is obtained in this determination, the control information update confirmation processing module 47 proceeds to step S74.

On the other hand, if a positive result is obtained in the determination of step S70, the control information update confirmation processing module 47 selects one global order guarantee information that has not been processed in step S73 and step S74 and having the smallest global sequence number among the global order guarantee information updated from the previous control information update confirmation process to the present (S71). Further, the control information update confirmation processing module 47 executes a log saving process for saving, in the control information log region 36 (FIG. 7) of the storage device 12, a global order guarantee information log created in association with the update of the global order guarantee information selected in step S71 (hereinafter referred to as selected global order guarantee information) (S72).

Further, the control information update confirmation processing module 47 executes a log reflection process of reflecting, in the control information held by the corresponding standby storage control unit 22, a change in control information stored in the control information log region 36 of the storage device 12 accompanying the log saving process of step S72 (S73).

Subsequently, the control information update confirmation processing module 47 acquires, from the group management table 52 (FIG. 11), a local group number of the local group 25 (FIG. 4) to which a logical volume of the volume number notified from the write processing module 41 at the time of starting the control information update confirmation process belongs (S74).

Next, for the local group 25 having the local group number acquired in step S74, the control information update confirmation processing module 47 executes a log saving process for saving, in the storage device 12, a local order guarantee information log related to each logical volume belonging to the local group 25 (S75).

Further, the control information update confirmation processing module 47 executes a log reflection process of reflecting, in the control information held by the corresponding standby storage control unit 22, a change in control information stored in the control information log region 36 of the storage device 12 accompanying the log saving process of step S75 (S76).

Thereafter, the control information update confirmation processing module 47 determines whether the processes of step S72 and step S73 have been completed for all the global order guarantee information updated from the previous control information update confirmation process to the present (S77).

If a negative result is obtained in this determination, the control information update confirmation processing module 47 returns to step S71, and then repeats the processes of step S71 to step S77 while sequentially switching the global order guarantee information selected in step S71 to an unprocessed global order guarantee log in step S72 and step S73.

If a positive result is eventually obtained in step S77 by completing the processes in step S72 and step S73 for all the global order guarantee information updated from the previous control information update confirmation process to the present, the control information update confirmation processing module 47 ends the control information update confirmation process.

### Log Saving Process

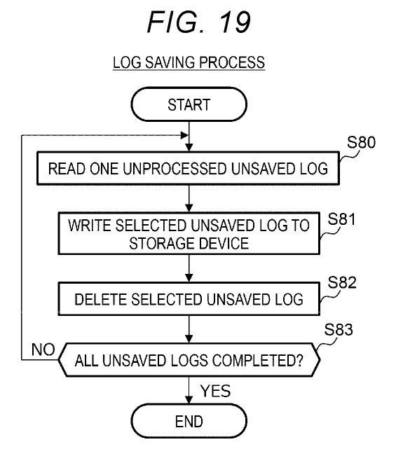

FIG. 19 illustrates a processing procedure of the log saving process executed by the control information update confirmation processing module 47 in step S72 or step S74 of the control information update confirmation process. The control information update confirmation processing module 47 saves a necessary global order guarantee information log and local order guarantee information log in the storage device 12 according to the processing procedure illustrated in FIG. 19.

In practice, when the process proceeds to step S72 or step S74 of the control information update confirmation process, the control information update confirmation processing module 47 starts the log saving process illustrated in FIG. 19, first reads a global order guarantee information log of the selected global order guarantee information from the global order guarantee information log queue 28 (FIG. 4) in step S72 of the control information update confirmation process, and reads one unsaved local order guarantee information log from the corresponding first or second local order guarantee information log queue 26,27 (FIG. 4) in step S74 of the control information update confirmation process (S80).

Subsequently, the control information update confirmation processing module 47 writes, into the storage device 12, the global order guarantee information log or the local order guarantee information log read in step S80 (S81). At this time, the control information update confirmation processing module 47 writes the CD log, the L-SM log, and the G-SM log into the control information log region 36 (FIG. 7) of the storage device 12, and writes the CM log into the cache data log region 37 (FIG. 7).

When writing the global order guarantee information log or the local order guarantee information log into the control information log region 36 or the cache data log region 37 of the storage device 12, the control information update confirmation processing module 47 writes the global order guarantee information log or the local order guarantee information log into the control information log region 36 or the cache data log region 37 subsequently to the global order guarantee information log or the local order guarantee information log written last.

Next, the control information update confirmation processing module 47 deletes the global order guarantee information log or the local order guarantee information log written in the storage device 12 in step S81 from the original global order guarantee information log queue 28 or the first or second local order guarantee information log queue 26,27 (S82).

Thereafter, in the case of step S72 of the control information update confirmation process, the control information update confirmation processing module 47 ends the log saving process. In the case of step S75 of the control information update confirmation process, the control information update confirmation processing module 47 determines whether all the global order guarantee information logs or local order guarantee information logs to be processed have been written into the storage device 12 (S83).

If a negative result is obtained in this determination, the control information update confirmation processing module 47 returns to step S80, and then repeats the processes of step S80 to step S83 while sequentially switching the global order guarantee information log or the local order guarantee information log selected in step S80 to another corresponding global order guarantee information log or local order guarantee information log that has not been saved in the storage device 12.

If a positive result is eventually obtained in step S83 by completing saving all the necessary global order guarantee information logs or local order guarantee information logs in the storage device 12, the control information update confirmation processing module 47 ends the log saving process.

### Log Reflection Process

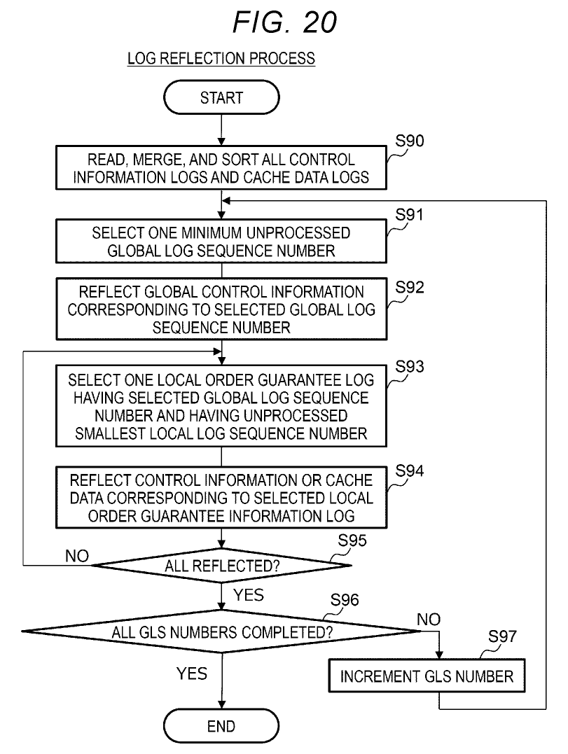

FIG. 20 illustrates a processing procedure of the log saving process executed by the control information update confirmation processing module 47 in step S73 or step S76 of the control information update confirmation process. The control information update confirmation processing module 47 reflects a change in control information managed by the own storage control unit 22, which is an active storage control unit, in the control information held by the standby storage control unit 22 constituting the same storage control unit group 24 according to the processing procedure illustrated in FIG. 20.

In practice, when the process proceeds to step S73 or step S76 of the control information update confirmation process, the control information update confirmation processing module 47 starts the log reflection process. The control information update confirmation processing module 47 first reads all of the global order guarantee information logs and the local order guarantee information logs stored in the control information log region 36 (FIG. 7) and the cache data log region 37 (FIG. 7) of the storage device 12, merges the global order guarantee information logs and the local order guarantee information logs, and sorts the global order guarantee information logs and the local order guarantee information logs in the number order of the global log sequence numbers stored in a global log sequence number field 50B (FIG. 9) of the log header 50 (FIG. 9) (S90). Specifically, the control information update confirmation processing module 47 arranges the merged global order guarantee information logs and local order guarantee information logs in order from the smallest global log sequence number.

Subsequently, the control information update confirmation processing module 47 selects one global log sequence number having the smallest value among the global log sequence numbers that have not been processed in step S92 and subsequent steps (S91), and transmits control information corresponding to the selected global log sequence number (hereinafter, referred to as a selected global log sequence number) to the standby storage control unit 22 constituting the same storage control unit group 24 (S92). Thus, the standby storage control unit 22 that has received the control information reflects (overwrites) the received control information in the control information held by the standby storage control unit 22.

Next, the control information update confirmation processing module 47 selects, from the local order guarantee information logs whose selected global log sequence numbers are stored in the global log sequence number field 50B (FIG. 9) of the log header 50, one local order guarantee information log having the smallest local log sequence number stored in the local log sequence number field 50C (FIG. 9) of the log header 50 and not processed in step S104 and subsequent steps (S93), and transmits control information or cache data corresponding to the selected local order guarantee information log (hereinafter referred to as a selected local order guarantee information log) to the standby storage control unit 22 constituting the same storage control unit group 24 (S94). The standby storage control unit 22 that has received the control information reflects (overwrites) the received control information in the control information held by the standby storage control unit 22.

Thereafter, the control information update confirmation processing module 47 determines whether the process of step S94 has been completed for all the local order guarantee information logs whose selected global log sequence numbers are stored in the global log sequence number field 50B of the log header 50 (S95).

If a negative result is obtained in this determination, the control information update confirmation processing module 47 returns to step S93, and then repeats the processes of step S93 to step S95 while sequentially switching the local order guarantee information log selected in step S93 to another local order guarantee information log that has not been processed in step S94.

If a positive result is eventually obtained in step S95 by completing reflecting all local order guarantee information logs whose selected global log sequence numbers are stored in the global log sequence number field 50B of the log header 50, the control information update confirmation processing module 47 determines whether the processes of step S92 to step S95 have been completed for all the global log sequence numbers sorted in step S90 (S96).

If a negative result is obtained in this determination, the control information update confirmation processing module 47 increments (increases by "1") the global log sequence number (S97), and then returns to step S91. Thereafter, the control information update confirmation processing module 47 repeats the processes of steps S91 to S97 while sequentially switching the global log sequence number selected in step S91 to a global log sequence number sorted in step S90 and having the smallest value among the global log sequence numbers that have not been processed in step S92 and the subsequent steps.

If a positive result is eventually obtained in step S96 by completing the processes in step S92 and subsequent steps for all the global storage numbers sorted in step S90, the control information update confirmation processing module 47 ends the log reflection process. As described above, the update of the control information held by the active storage control unit 22 is reflected in the control information held by the standby storage control unit 22 constituting the same storage control unit group 24.

### Log Recovery Process

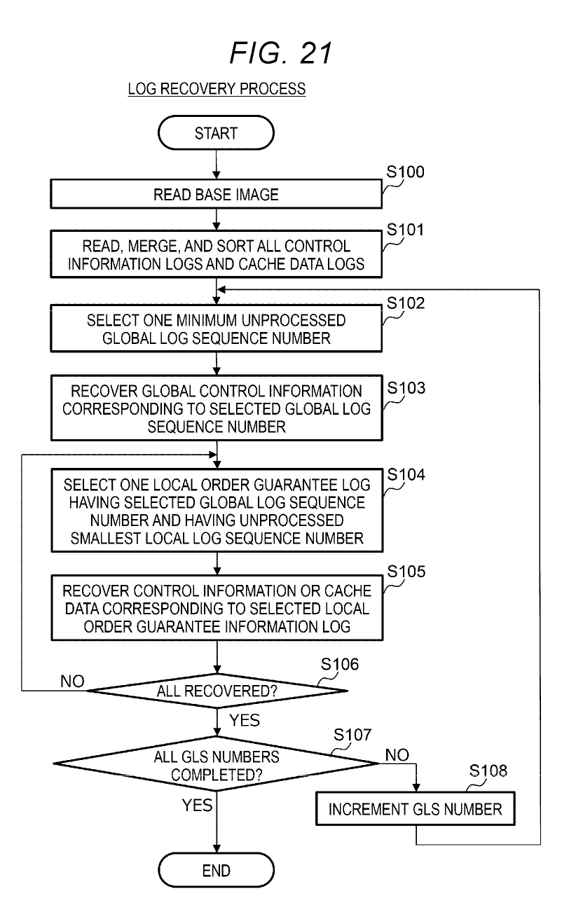

FIG. 21 illustrates a processing procedure of a log recovery process executed by the log recovery processing module 48 (FIG. 8) at the time of restart after power interruption. The log recovery processing module 48 recovers a state of a log in the memory 11 to a state of the base image stored in the control information base image region 35 by executing the log recovery process at the time of restart after power interruption.

In practice, when the restart after the power interruption is started, the log recovery processing module 48 starts the log recovery process, and first reads the base image stored in the control information base image region 35 (FIG. 7) of the storage device 12 (S100).

Subsequently, the log recovery processing module 48 first reads all of the global order guarantee information logs and the local order guarantee information logs stored in the control information log region 36 (FIG. 7) and the cache data log region 37 (FIG. 7) of the storage device 12, merges the global order guarantee information logs and the local order guarantee information logs, and sorts the global order guarantee information logs and the local order guarantee information logs in the number order of the global log sequence numbers stored in the global log sequence number field 50B (FIG. 9) of the log header 50 (FIG. 9) (S101). Specifically, the log recovery processing module 48 arranges the merged global order guarantee information log and local order guarantee information log in order from the smallest global log sequence number.

Subsequently, the log recovery processing module 48 selects one global log sequence number having the smallest value among the global log sequence numbers that have not been processed in step S93 and subsequent steps (S102), and recovers the control information corresponding to the selected global log sequence number (hereinafter referred to as a selected global log sequence number) (S103).

Next, the log recovery processing module 48 selects, from the local order guarantee information logs whose selected global log sequence numbers are stored in the global log sequence number field 50B (FIG. 9) of the log header 50, one local order guarantee information log having the smallest local log sequence number stored in the local log sequence number field 50C (FIG. 9) of the log header 50 and not processed in step S105 and subsequent steps (S104), and recovers control information or cache data corresponding to the selected local order guarantee information log (hereinafter referred to as a selected local order guarantee information log) (S105).

"Recovery" in step S103 and step S105 refers to reflecting (writing) the corresponding control information or cache data in the storage control information region 30 (FIG. 5) or the cache data region 31 (FIG. 5) on the memory 11 based on an address stored in the update address field 50D (FIG. 9) of the log header 50 of the corresponding global order guarantee information log or local order guarantee information log.

Thereafter, the log recovery processing module 48 determines whether the process of step S105 has been completed for all the local order guarantee information logs whose selected global log sequence numbers are stored in the global log sequence number field 50B of the log header 50 (S106).

If a negative result is obtained in this determination, the log recovery processing module 48 returns to step S104, and then repeats the processes of step S104 to step S106 while sequentially switching the local order guarantee information log selected in step S104 to another local order guarantee information log that has not been processed in step S105.

If a positive result is eventually obtained in step S106 by completing the recovery of all the local order guarantee information logs whose selected global log sequence numbers are stored in the global log sequence number field 50B of the log header 50, the log recovery processing module 48 determines whether the processes of step S103 to step S106 have been completed for all the global log sequence numbers sorted in step S101 (S107).

If a negative result is obtained in this determination, the log recovery processing module 48 increments the global log sequence number (increases the global log sequence number by "1") (S108), and then returns to step S102. Then, the log recovery processing module 48 repeats the processing of step S102 to step S108 while sequentially switching the global log sequence number selected in step S102 to the global log sequence number having the smallest value among the unprocessed global log sequence numbers, which is a global storage number, sorted in step S101 and in step S103 and subsequent steps.

If a positive result is eventually obtained in step S107 by completing processes in step S103 and subsequent steps for all the global storage numbers sorted in step S101, the log recovery processing module 48 ends the log recovery process. Accordingly, the recovery of the control information and the cache data after the power interruption is completed.

In the local groups 25 (FIG. 4), it is necessary to recover the local order guarantee information logs in ascending order of the local log sequence number, but it is not necessary to guarantee the order for recovering the local order guarantee information logs between different local groups 25. Therefore, the log recovery processing can be performed in parallel between the local groups 25.

### Effects of Present Embodiment

As described above, in the storage system 1 according to the present embodiment, for each storage control unit group 24, a log created in association with each logical volume associated with the storage control unit group 24 is divided into a local order guarantee information log whose order may be guaranteed in the group and a global order guarantee information log whose order needs to be guaranteed with another group, and the local order guarantee information log is divided into a plurality of groups.

For the global order guarantee information log, a sequence number (global log sequence number and/or local log sequence number) for guaranteeing the order between the global order guarantee information log and another global order guarantee information log is assigned, and for the local order guarantee information log, a sequence number (global log sequence number and/or local log sequence number) for guaranteeing the order between the global order guarantee information log and other local order guarantee information logs in the same group is assigned.

Furthermore, various processes such as an asynchronous destage process, transmission and reception for the local order guarantee information log and global order guarantee information log are executed in parallel for the local order guarantee information log and the global order guarantee information log of each group.

Therefore, according to the present storage system 1, it is possible to improve a processing speed of various processes such as an asynchronous destage process, transmission, and reception for logs, and it is possible to improve the corresponding performance. Further, according to each storage system 1, the order of the local order guarantee information log and the global order guarantee information log can be reliably guaranteed. Therefore, according to the present storage system 1, the performance and reliability can be improved.

### Second Embodiment

In FIG. 1, reference numeral 60 denotes a storage system according to a second embodiment as a whole. This storage system is largely different from the storage system 1 according to the first embodiment in that a configuration of the local group 25 described above with reference to FIG. 4 is different, and is configured similarly to the storage system 1 according to the first embodiment in other respects.

In practice, in the storage system 1 according to the first embodiment, the local groups 25 are collectively configured in units of logical volumes, but in the storage system 60 according to this embodiment, the address ranges of a plurality of logical volumes are collectively configured in units of address ranges of storage areas of each logical volume to configure the local groups 25.

The second embodiment is similar to the first embodiment in that the first local order guarantee information log queue 26 is provided in association with each local group 25, the second local order guarantee information log queue 27 is provided in association with the L-SM log, and the global order guarantee information log queue 28 is provided in association with the G-SM log.

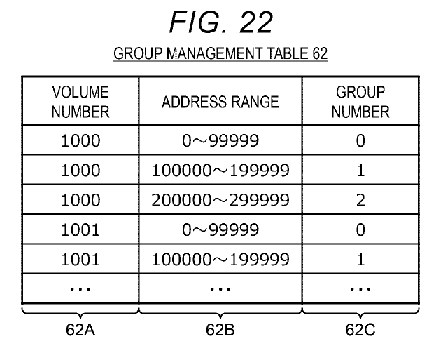

FIG. 22 illustrates a configuration of a group management table 62 held by the storage node 61 according to the present embodiment instead of the group management table 52 according to the first embodiment described above with reference to FIG. 11.

The group management table 62 is a table created by the active storage control unit 22 (FIG. 3) for each storage control unit group 24 (FIG. 3), and is used to manage to which local group 25 (FIG. 4) an address range of each divided storage area of the logical volume associated with the storage control unit group 24 belongs.

In the group management table 62, one entry (row) corresponds to an address range of a part or all of the divided storage areas of one logical volume, and every time a new logical volume is created and a part or all of the address ranges of the storage area of the logical volume is allocated to one of the local groups 25, the part or all of the address ranges are registered in the group management table 62. The group management table 62 is also stored and managed in the control information base image region 35 of the storage device 12.

The group management table 62 includes a volume number column 62A, an address range column 62B, and a group number column 62C. The volume number column 62A stores volume numbers of all the logical volumes associated with the corresponding storage control unit group 24.

The address range column 62B stores the corresponding address range in the storage area of the corresponding logical volume, and the group number column 62C stores an identification number (local group number) of the local group 25 to which the corresponding address range in the storage area of the corresponding logical volume is allocated.

As a method of dividing a storage area of a logical volume, various division methods such as a method of dividing a storage area into storage areas of a predetermined size and a method set by the user can be applied. Further, as a method of allocating the divided storage areas of these logical volumes to the respective local groups 25, various allocation methods such as a method of allocating the divided storage areas in order to a fixed number of local groups 25 by a round robin method or a method of allocating the divided storage areas to the respective local groups 25 using random numbers can be widely applied.

According to the storage system 60 of the present embodiment having the above configuration, since the processes such as creating, saving, and reflecting a log can be performed in parallel with respect to the I/O performance to one or a smaller number of logical volumes, the performance of the entire storage system 60 can be further improved.

### Other Embodiments

In the first and second embodiments described above, a case where the present invention is applied to the storage node 4 constituting the storage system 1 as illustrated in FIG. 1 has been described, but the present invention is not limited thereto, and can be widely applied to storage devices constituting various other storage systems.

Further, in the first and second embodiments described above, the case where the serial number starting from "1" is applied as the local log sequence number or the global log sequence number assigned to the local order guarantee information log or the global order guarantee information log has been described, but the present invention is not limited thereto, and various other numbers can be widely applied.

Further, in the first and second embodiments described above, as a method of allocating logical volumes to the local groups 25, a method of allocating the logical volumes regardless of the function of the storage system 1, such as a method using a volume number or a random number, has been described, but the present invention is not limited thereto, and for example, a load of the CPU core such as the number of I/Os may be estimated and the load may be averaged, and further, the logical volumes may be allocated to the local groups 25 to average the capacity.

### Industrial Applicability

The present invention can be widely applied to storage devices having various configurations for creating a log according to an update content when information is updated.

What is claimed is:

1. A storage device that includes a processor, a volatile memory, and a plurality of non-volatile drives and performs data input and output, wherein
when performing an operation, the processor
creates a log according to an update content updated by the operation and stores the created log in the memory, and
stores the log stored in the memory in the drive and non-volatilizes the log,
the log being divided into a first log and a second log according to a type of the log,
the first log being divided into a plurality of groups, and
when processing the log, the processor
processes the first log and the second log in a predetermined order, and
processes the first log in the groups in a predetermined order determined in the groups, and processes the first log in parallel between the groups.

2. The storage device according to claim 1, wherein
the log includes a sequence number indicating a processing order of the log, and the process is performed in an order based on the sequence number,
the first log includes group identification information, a first sequence number indicating a processing order in the groups, and a second sequence number indicating a processing order between logs including a log outside the group,
the second log includes the second sequence number,
the order of the first log and the second log follows the second sequence number, and
the order of the first log follows the first sequence number in the groups, and the first log is available to be processed in parallel between the groups.

3. The storage device according to claim 2, further comprising:
a plurality of nodes each including the processor, the volatile memory, and the plurality of non-volatile drives, wherein
a redundancy group is configured with the plurality of nodes,
the process of the log includes storing the log in at least two nodes and doubling the log by transferring the log to another node of the redundancy group and storing the log, and
the processor
assigns the sequence number to the log when creating the log, and
processes the log in an order according to the sequence number when processing the log.

4. The storage device according to claim 1, wherein
the first log includes an update log of cache data and an update log of a cache directory related to a cache stored in the memory when the data input and output is performed, and
the second log includes a configuration change log for changing a configuration of a logical volume provided by the processor to a host device or a path connecting the logical volume and the host device.

5. The storage device according to claim 1, wherein
when receiving the processor receives a write command as the operation, the processor
stores, in the memory, an update content updated by the write command,
creates a log according to the update content, processes the created log, and stores the log in a good faith drive,
transmits a response to the write command after the log is stored in the drive, and
destages the update content of the memory to the drive.

6. The storage device according to claim 2, wherein
the groups of the first log include a first group including an update log of cache data and a second group including an update log of a cache directory.

7. The storage device according to claim 1, wherein
the processor provides a plurality of logical volumes as a storage area to a host device,
the logical volumes are divided in association with the plurality of groups related to the first log, and
the processor adds, to the group related to the corresponding first log, the first log created according to an update content of an operation performed on each of the logical volumes.

8. The storage device according to claim 1, wherein
the processor provides a logical volume as a storage area to a host device,
the storage area of the provided logical volume is divided into the plurality of groups related to the first log in units of address ranges, and
the processor adds, to the group related to the corresponding first log, the first log created according to an update content of an operation performed on each address range of the logical volume.

9. A control method for a storage device, the storage device including a processor, a volatile memory, and a plurality of non-volatile drives and configured to perform data input and output, the control method comprising:
when performing an operation, by the processor,
creating a log according to an update content updated by the operation and storing the created log in the memory; and
storing the log stored in the memory in the drive and non-volatilizing the log,
the log being divided into a first log and a second log according to a type of the log,
the first log being divided into a plurality of groups, and
when processing the log, by the processor,
a processing step of processing the first log and the second log in a predetermined order and processing the first log in the groups in a predetermined order determined in the groups, and processing the first log in parallel between the groups.

10. The control method for a storage device according to claim 9, wherein
the log includes a sequence number indicating a processing order of the log, and the process is performed in an order based on the sequence number,
the first log includes group identification information, a first sequence number indicating a processing order in the groups, and a second sequence number indicating a processing order between logs including a log outside the group,
the second log includes the second sequence number,
in the processing step, by the processor,
the order of the first log and the second log follows the second sequence number, and
the order of the first log follows the first sequence number in the groups, and the first log is available to be processed in parallel between the groups.

11. The control method for a storage device according to claim 10, wherein
the storage device further includes:
a plurality of nodes each including the processor, the volatile memory, and the plurality of non-volatile drives,
a redundancy group is configured with the plurality of nodes,
the process of the log includes storing the log in at least two nodes and doubling the log by transferring the log to another node of the redundancy group and storing the log,
the processor assigns the sequence number to the log when creating the log, and
in the processing step, the processor
processes the log in an order according to the sequence number.

12. The control method for a storage device according to claim 9, wherein
the first log includes an update log of cache data and an update log of a cache directory related to a cache stored in the memory when the data input and output is performed, and
the second log includes a configuration change log for changing a configuration of a logical volume provided by the processor to a host device or a path connecting the logical volume and the host device.

13. The control method for a storage device according to claim 9, wherein
when receiving the processor receives a write command as the operation, the processor
stores, in the memory, an update content updated by the write command,
creates a log according to the update content, processes the created log, and stores the log in a good faith drive,
transmits a response to the write command after the log is stored in the drive, and
destages the update content of the memory to the drive.

14. The control method for a storage device according to claim 10, wherein
the groups of the first log include a first group including an update log of cache data and a second group including an update log of a cache directory.

15. The control method for a storage device according to claim 9, wherein
the processor provides a plurality of logical volumes as a storage area to a host device,
the logical volumes are divided in association with the plurality of groups related to the first log, and
the processor adds, to the group related to the corresponding first log, the first log created according to an update content of an operation performed on each of the logical volumes.

16. The control method for a storage device according to claim 9, wherein
the processor provides a logical volume as a storage area to a host device,
the storage area of the provided logical volume is divided into the plurality of groups related to the first log in units of address ranges, and
the processor adds, to the group related to the corresponding first log, the first log created according to an update content of an operation performed on each address range of the logical volume.
